(19) United States
(12) Patent Application Publication
(10) Pub. No.: US 2024/0166826 A1
(43) Pub. Date: May 23, 2024

(54) POLYESTER MASTER BATCH COMPOSITION, AND POLYESTER YARN CONTAINING SAME

(71) Applicant: Heon Sang KIM, Seoul (KR)

(72) Inventors: Heon Sang KIM, Seoul (KR); Gi Ju LEE, Anyang-si, Gyeonggi-do (KR)

(21) Appl. No.: 18/552,208

(22) PCT Filed: Mar. 25, 2022
(86) PCT No.: PCT/KR2022/004198

§ 371 Date: Sep. 25, 2023

(30) Foreign Application Priority Data
Mar. 25, 2021 (KR) 10-2021-0038824

(51) Int. Cl. C08J 3/22; C08K 3/04; C08K 5/17; D01F 1/10; D01F 6/62; D02G 3/02

(52) U.S. Cl. CPC C08J 3/22; C08K 3/042; C08K 5/17; D01F 1/106; D01F 6/62; D02G 3/02; C08J 2367/00; D10B 2331/04; D10B 2401/063; D10B 2401/13; D10B 2401/16; D10B 2401/22; D10B 2501/00; D10B 2509/00

(57) ABSTRACT

The present invention relates to a polyester master batch composition and a polyester yarn containing the composition, and more specifically, to a polyester master batch composition obtained by adding a graphene oxide dispersion liquid to polyester. The polyester master batch composition to which the graphene oxide is added as described above provides a polyester yarn further having far-infrared emissivity and antibacterial performance, as well as exhibiting lubricity, UV blocking properties, electrical conductivity, and heat dissipation properties, and having improved mechanical properties such as scratch resistance, abrasion resistance, tensile strength, flexural strength, and flexural modulus.

### CROSS-REFERENCE TO RELATED APPLICATIONS

This application is a National Stage Entry of International Application No. PCT/KR2022/004198 filed Mar. 25, 2022, which claims priority from Korean Application No. 10-2021-0038824 filed Mar. 25, 2021. The aforementioned applications are incorporated herein by reference in their entireties.

### TECHNICAL FIELD

The present disclosure relates to a polyester master batch composition and a polyester yarn containing the composition. More specifically, the present disclosure relates to a polyester master batch composition to produce polyester yarns imparted with far-infrared ray radiation and antibacterial functions, exhibiting lubricity, UV blocking properties, electrical conductivity, and heat dissipation properties, and having improved mechanical properties such as scratch resistance, abrasion resistance, tensile strength, flexural strength, and flexural modulus, and to a polyester yarn containing the composition.

### BACKGROUND ART

The term “master batch” refers to a highly concentrated functional resin that contains a mixture of functional ingredients such as additives at a high concentration and a dispersant, in which the additives function to impart various necessary functions to petrochemical industrial products including chemical fibers when they are manufactured, and the dispersion functions to prevent the functional ingredients such as additives from being poorly dispersed.

Synthetic fibers have superior mechanical properties to natural fibers but exhibit low absorptivity. Therefore, synthetic fibers allow sweat and various organic substances secreted from the human body to easily attach thereto, thereby providing an environment suitable for the habitation of microorganisms such as bacteria and fungi. The proliferation of these microorganisms may cause bad odors, discoloration, and contamination of textile products, and even diseases due to human infections. For this reason, many attempts have been made to impart textile materials with the function of suppressing the growth of bacteria harmful to the human body.

Meanwhile, graphenes are a two-dimensional material in the form of a single-atomic layer in which carbon atoms form a honeycomb-shaped hexagon and are connected by covalent bonds. Graphenes have thermal, mechanical, electrical, and optical properties that may overcome the fundamental limitations of existing materials, making it possible to be infinitely applied in various industrial fields such as barrier coating materials and ultra-light and high-strength composite materials.

However, since defect-free graphenes are difficult to uniformly disperse in polymer resins and organic solvents due to van der Waals forces between graphenes, it is difficult to produce coating materials and high-performance functional composites, and studies on practically applicable technologies are very limited. Studies on surface modification using various functional groups of graphene oxides are being actively conducted to solve this limitation of graphene dispersion. However, these studies have limitations of high reaction heat, low reproducibility, and unsuitability for mass production, so improvements are required.

The conventional arts are Korean Patent No. 10-1975955 (2019.04.30) and Korean Patent No. 10-2163232 (2020 Sep. 29).

### DISCLOSURE

### Technical Problem

The objective of the present disclosure is to provide a polyester master batch composition and a polyester yarn containing the composition, in which the polyester yarn is imparted with far-infrared ray radiation and antibacterial functions, exhibits lubricity, UV blocking properties, electrical conductivity, and heat dissipation properties, and has improved mechanical properties such as scratch resistance, abrasion resistance, tensile strength, flexural strength, and flexural modulus.

### Technical Solution

The objective of the present disclosure is achieved by providing a polyester master batch composition which contains a graphene oxide dispersion liquid.

According to a preferred feature of the present disclosure, the polyester master batch composition contains 99% to 99.9% by weight of polyester and 0.1% to 1% by weight of graphene oxide dispersion liquid.

According to a more preferred feature of the present disclosure, the graphene oxide dispersion liquid contains 100 parts by weight of ionized water, 0.1 to 1 part by weight of graphene, and 0.01 to 0.1 part by weight of a dispersant.

According to a more preferred feature of the present disclosure, the dispersant contains one or more selected from the group consisting of amine- and stearic acid-based materials.

In addition, the objective of the present disclosure may be achieved by providing a polyester yarn that contains the polyester master batch composition.

According to a preferred feature of the present disclosure, the polyester yarn contains the polyester master batch composition in an amount of 50 to 2000 ppm.

### Advantageous Effects

A polyester master batch composition according to the present disclosure and a polyester yarn containing the composition has an excellent effect in being imparted with far-infrared ray radiation and antibacterial functions, exhibiting lubricity, UV blocking properties, electrical conductivity, and heat dissipation properties, and having improved mechanical properties such as scratch resistance, abrasion resistance, tensile strength, flexural strength, and flexural modulus.

### BRIEF DESCRIPTION OF THE DRAWINGS

FIGS. 1 to 4 are test reports showing the physical properties of a polyester fabric produced through Example 4 of the present disclosure;

FIGS. 5 to 7 are test reports showing the physical properties of a polyester knitted fabric produced through Example 5 of the present disclosure;

FIGS. 8 to 16 are test reports showing the physical properties of an integrated mask with polyester produced through Example 6 of the present disclosure;

FIGS. 17 to 24 are test reports showing the physical properties of a polyester health mask produced through Example 7 of the present disclosure;

FIGS. 25 and 26 are test reports showing the physical properties of polyester leggings produced through Example 8 of the present disclosure;

FIGS. 27 and 28 are test reports showing the physical properties of polyester socks produced through Example 9 of the present disclosure; and

FIGS. 29 to 32 are test reports showing the physical properties of a polyester hijab produced through Example 10 of the present disclosure.

### MODE FOR DISCLOSURE

Hereinafter, the preferred embodiment of the present disclosure and the physical properties of each ingredient will be described in detail, which is provided to allow those skilled in the art to easily implement the present disclosure. However, the technical scope and spirit of the present disclosure are not limited to the embodiments described herein below.

A polyester master batch composition according to the present disclosure contains a graphene oxide dispersion liquid and preferably contains 99% to 99.9% by weight of polyester and 0.18 to 18 by weight of the graphene oxide dispersion liquid.

The polyester master batch composition containing the graphene oxide dispersion liquid as described above is mixed with polyester, and thus the polyester yarn exhibits lubricity, UV blocking, electrical conductivity, and heat dissipation properties and has improved mechanical properties such as scratch resistance, abrasion resistance, tensile strength, flexural strength, and flexural modulus.

When the content of the graphene oxide dispersion liquid is less than 0.18 by weight, the effects are minimal. When the content of the graphene oxide dispersion liquid exceeds 18 by weight, the effects are not significantly improved, the mechanical properties of the polyester yarn deteriorate, and production costs excessively increase.

At this time, the graphene oxide dispersion liquid contains 100 parts by weight of ionized water, 0.1 to 1 part by weight of graphene, and 0.01 to 0.1 part by weight of a dispersant, and the ionized water serves to neutralize graphene in the form of a nano-level thin sheet exfoliated from graphite. The dispersant serves to ensure that the graphene is uniformly dispersed in the ionized water to provide a graphene oxide dispersion liquid having homogeneous physical properties.

In addition, the polyester master batch composition containing the ingredients is physically mixed with polyester pellets and then used to produce a polyester yarn through a melting process. After the production of a master batch as described above, the composition is physically mixed with polyester pellets. After the melting process, it is possible to provide a polyester yarn in which the physical properties shown by the polyester master batch composition according to the present disclosure are evenly expressed.

At this time, the polyester master batch composition according to the present disclosure is preferably contained in a pellet-type polyester at a concentration in a range of 50 to 200 ppm. When the content of the polyester master batch composition is less than 50 ppm, the improved effects of the physical properties such as far-infrared ray radiation, antibacterial function, lubricity, UV blocking properties, electrical conductivity, heat dissipation properties, scratch resistance, abrasion resistance, tensile strength, flexural strength, and flexural modulus are minimal. When the content of the polyester master batch composition exceeds 200 ppm, the effects are not significantly improved, the physical properties of the polyester yarn are lowered, and production costs excessively increase.

Hereinafter, a method of preparing a polyester master batch composition according to the present disclosure and the physical properties of a polyester yarn containing the master batch produced by the method will be described with reference to examples.

### <Preparation Example 1> Preparation of Graphene Oxide Dispersion Liquid

A graphene oxide dispersion liquid was prepared by mixing 100 parts by weight of ionized water, 0.5 part by weight of graphene, and 0.05 part by weight of a dispersant (amine-based dispersants).

### Example 1

A polyester master batch composition was prepared by mixing 99.9% by weight of polyester and 0.1% by weight of the graphene oxide dispersion liquid prepared through Preparation Example 1.

### Example 2

A polyester master batch composition was prepared by mixing 99.5% by weight of polyester and 0.5% by weight of the graphene oxide dispersion liquid prepared through Preparation Example 1.

### Example 3

A polyester master batch composition was prepared by mixing 99% by weight of polyester and 1% by weight of the graphene oxide dispersion liquid prepared through Preparation Example 1.

### COMPARATIVE EXAMPLE 1

Polyester Resin.

The physical properties of the polyester master batch composition prepared through Examples 1 to 3 and the physical properties of polyester of Comparative Example 1 were measured and shown in Table 1 below.

TABLE 1

| | | Example | Example | Example | Comparative | Measurement |
|---|---|---|---|---|---|---|
| Division | Unit | 1 | 2 | 3 | Example 1 | Method |
| Density | g/cm³ | 1.371 | 1.376 | 1.380 | 1.366 | ASTM D-792 |
| Tensile | Mpa | 62.8 | 65.5 | 69.4 | 61.9 | ASTM D-638 |
| Strength | | | | | | |
| Elongation | % | 9.7 | 7.1 | 5.5 | 14 | ASTM D-638 |
| Flexural | Mpa | 89 | 93 | 98 | 82 | ASTM D-648 |
| Strength | | | | | | |
| Flexural | Mpa | 2,381 | 2,586 | 2,885 | 2,270 | ASTM D-648 |
| Modulus | | | | | | |
| Impact | J/m | 22.5 | 20.4 | 20 | 28 | ASTM-1236D |
| Strength | | | | | | |
| (IZOD, 1/4″) | | | | | | |

As shown in Table 1, it may be seen that the polyester master batch composition prepared through Examples 1 to 3 of the present disclosure has mechanical properties significantly improved such as tensile strength, flexural strength, and flexural modulus.

### Example 4

A polyester yarn was produced by mixing 1000 ppm of the polyester master batch composition prepared in Example 2 with polyester and extruding the mixture, and the yarn was woven to produce a polyester fabric.

### Example 5

A polyester yarn was produced by mixing 1000 ppm of the polyester master batch composition prepared in Example 2 with polyester and extruding the mixture, and the yarn was woven to produce a polyester knitted fabric.

### Example 6

A polyester yarn was prepared by mixing 1000 ppm of the polyester master batch composition prepared in Example 2 with polyester and extruding the mixture, and the yarn was woven to prepare an integrated mask.

### Example 7

A polyester yarn was produced by mixing 1000 ppm of the polyester master batch composition prepared in Example 2 with polyester and extruding the mixture, and the yarn was woven to produce a health mask.

### Example 8

A polyester yarn was produced by mixing 1000 ppm of the polyester master batch composition prepared in Example 2 with polyester and extruding the mixture, and the yarn was woven to produce polyester leggings.

### Example 9

A polyester yarn was produced by mixing 1000 ppm of the polyester master batch composition prepared in Example 2 with polyester and extruding the mixture, and the yarn was woven to produce polyester socks.

### Example 10

A polyester yarn was produced by mixing 1000 ppm of the polyester master batch composition prepared in Example 2 with polyester extruding the mixture, and the yarn was woven to produce a polyester hijab.

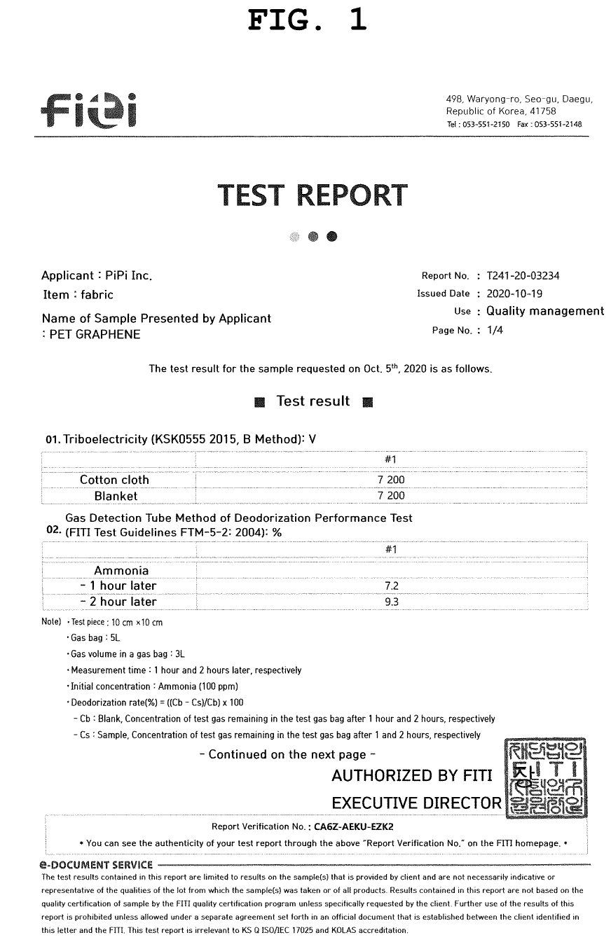

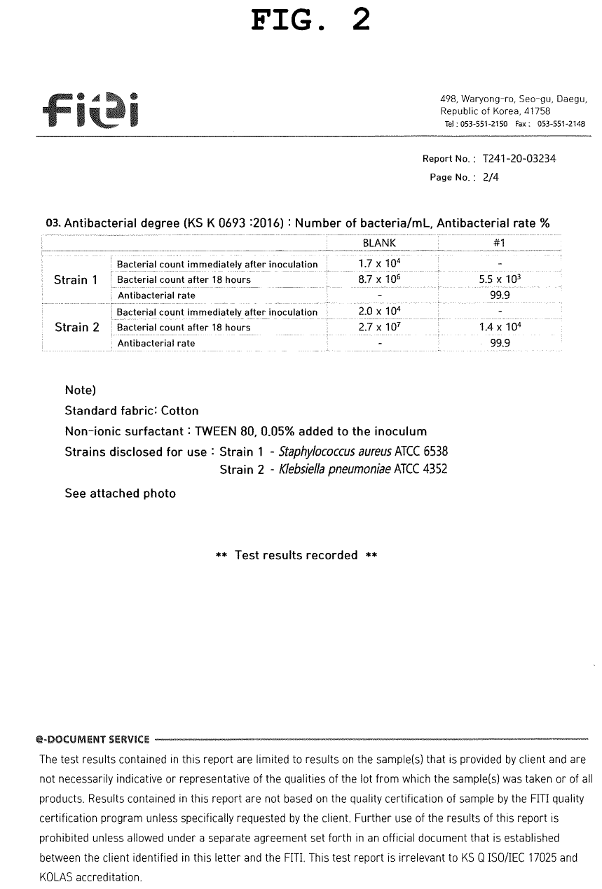

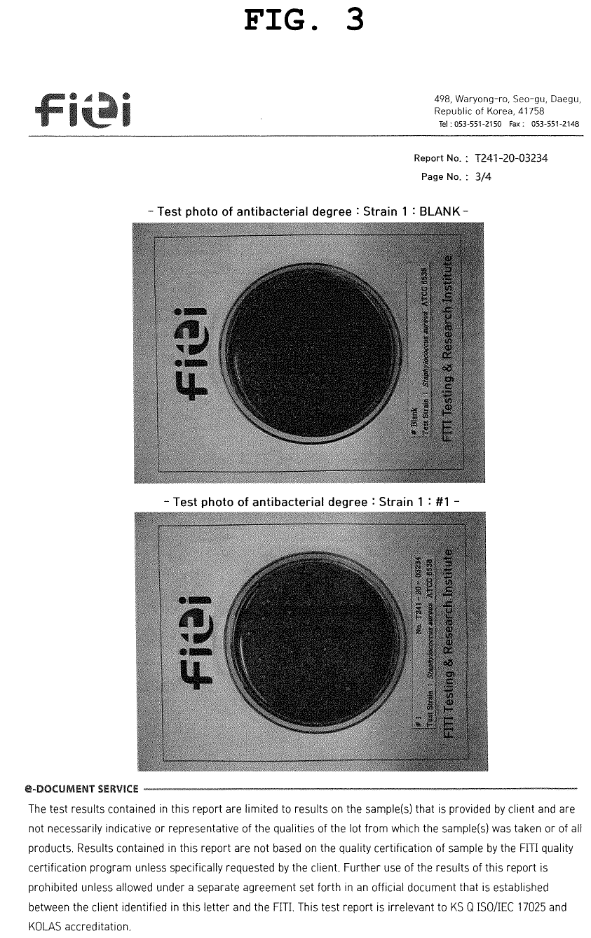

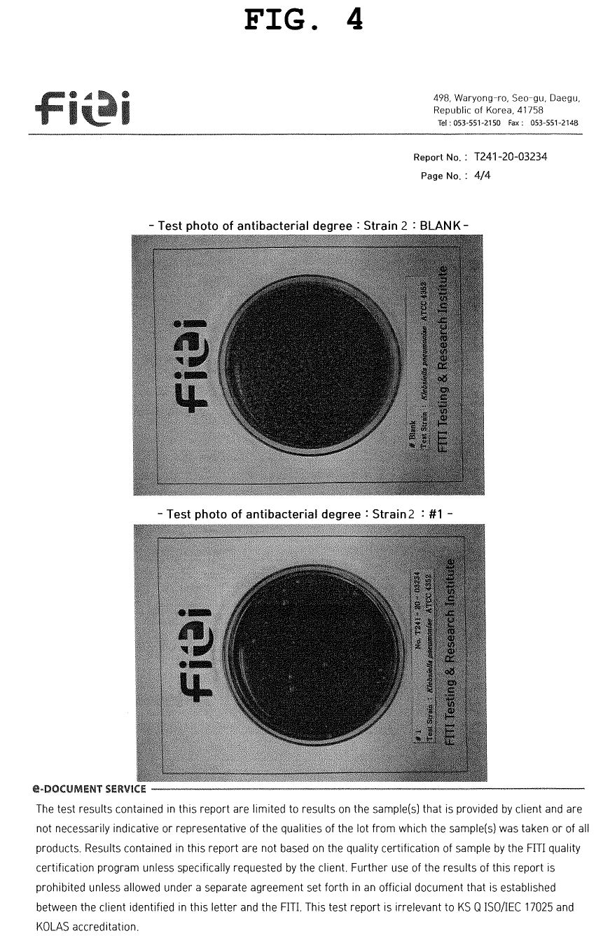

Test results for the antistatic, deodorizing, and antibacterial properties of the polyester fabric produced in Example 4 are shown in FIGS. 1 to 4 below by requesting the FITI Testing Research Institute to conduct the consignment tests.

As shown in FIGS. 1 to 4 below, it may be seen that the polyester fabric produced through Example 4 of the present disclosure exhibits excellent antistatic, deodorizing, and antibacterial properties.

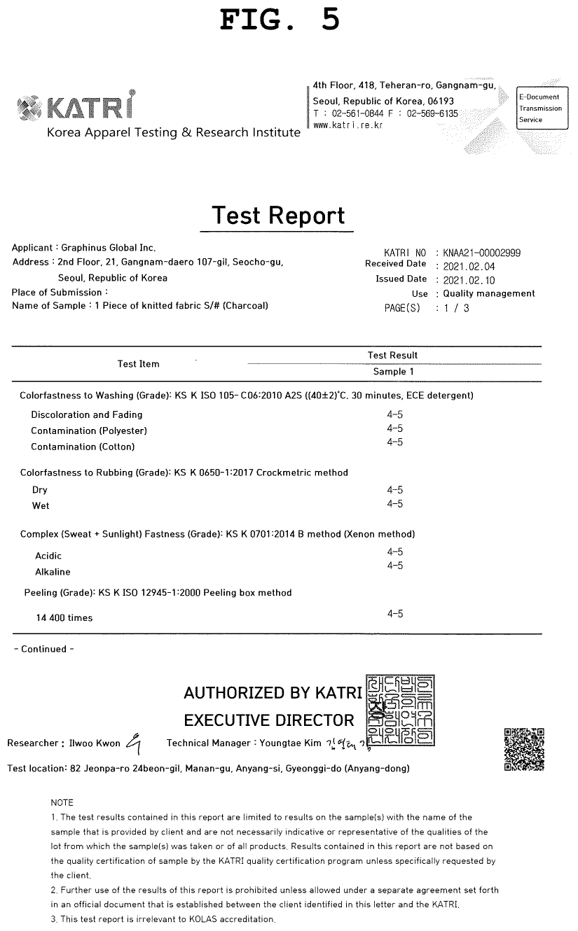

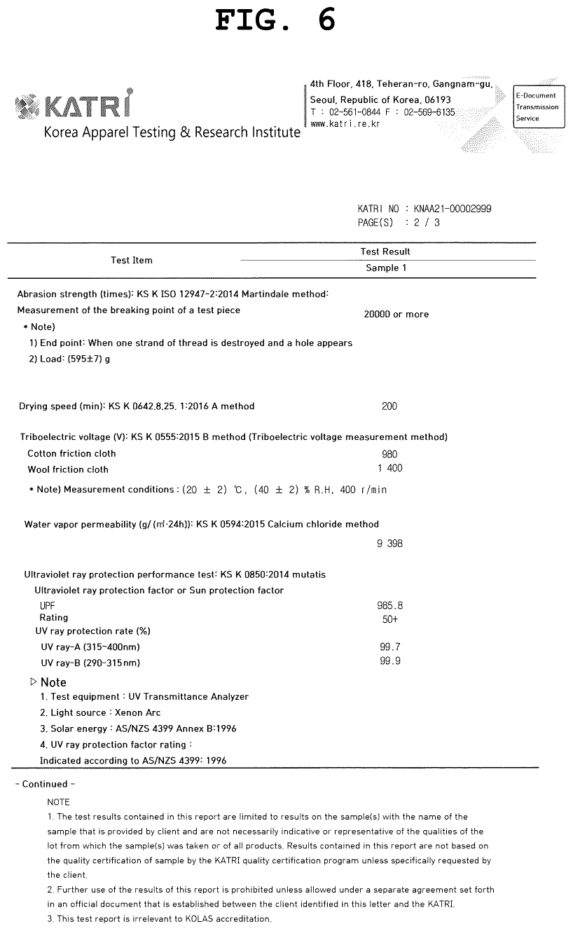

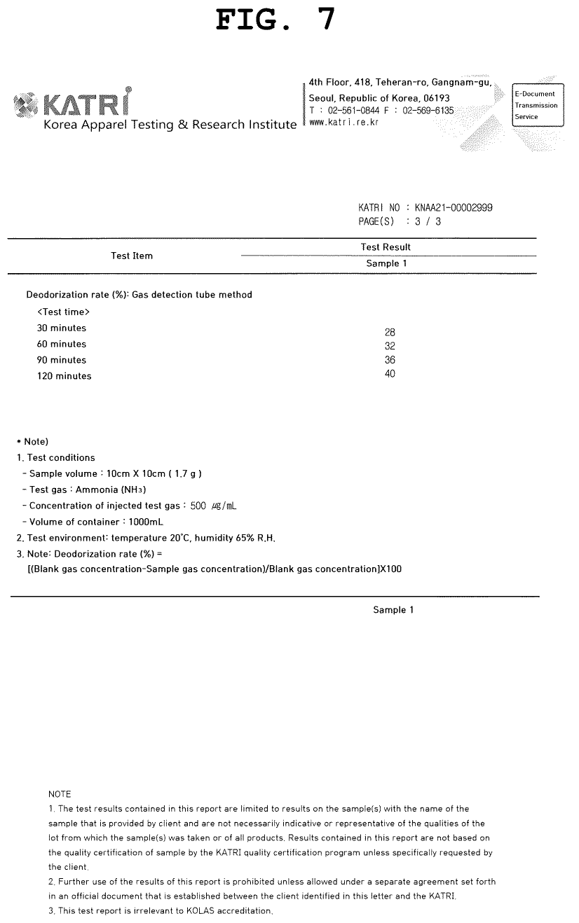

In addition, test results for colorfastness to washing and colorfastness to rubbing of the polyester knitted fabric produced in Example 5 are shown in FIGS. 5 to 7 below by requesting the Korea Apparel Testing & Research Institute to conduct the consignment tests.

As shown in FIGS. 5 to 7 below, it may be seen that the polyester knitted fabric produced through Example 5 of the present disclosure exhibits an excellent colorfastness to washing and colorfastness to rubbing.

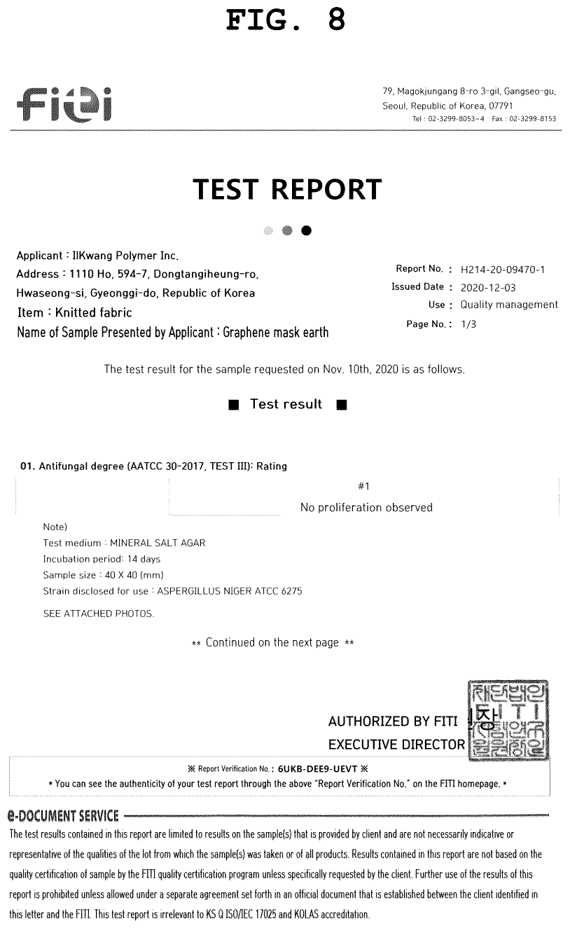

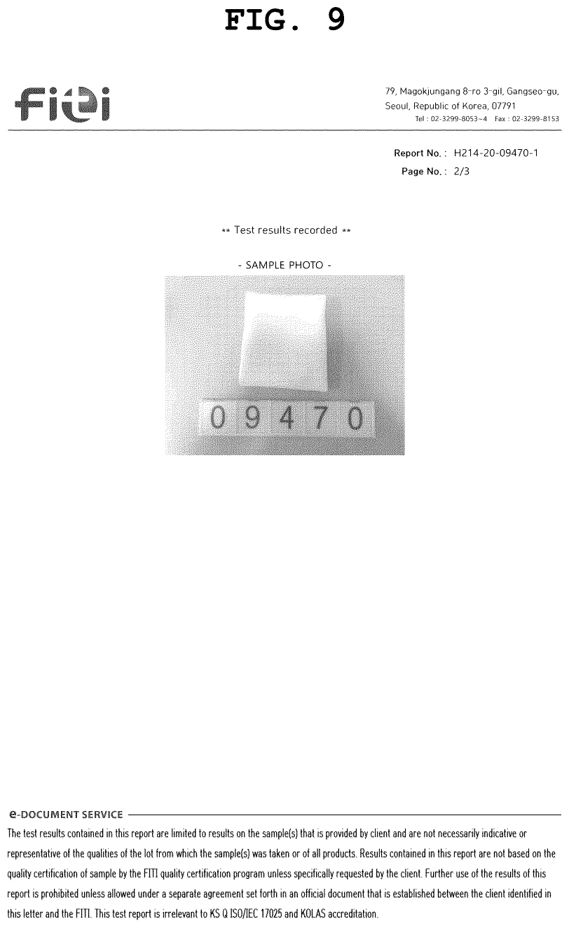

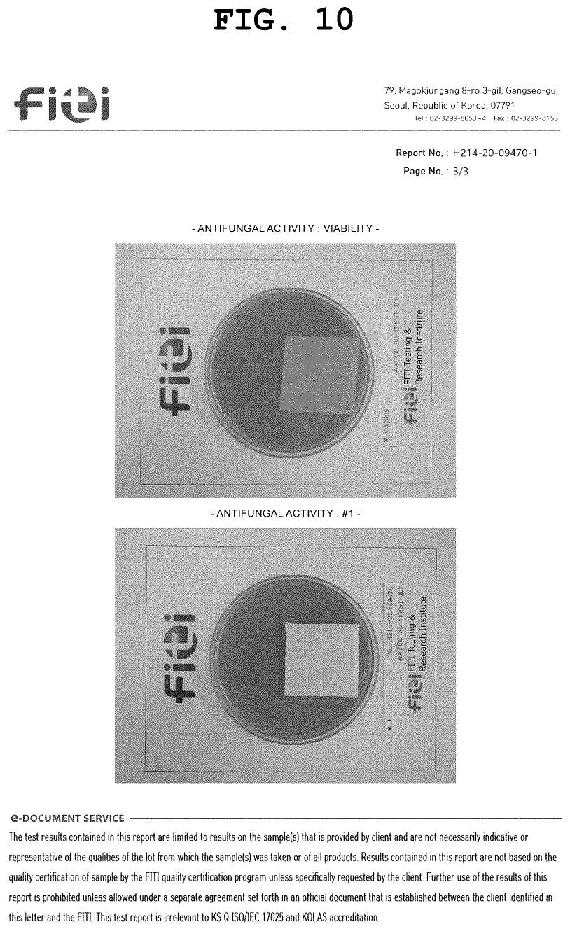

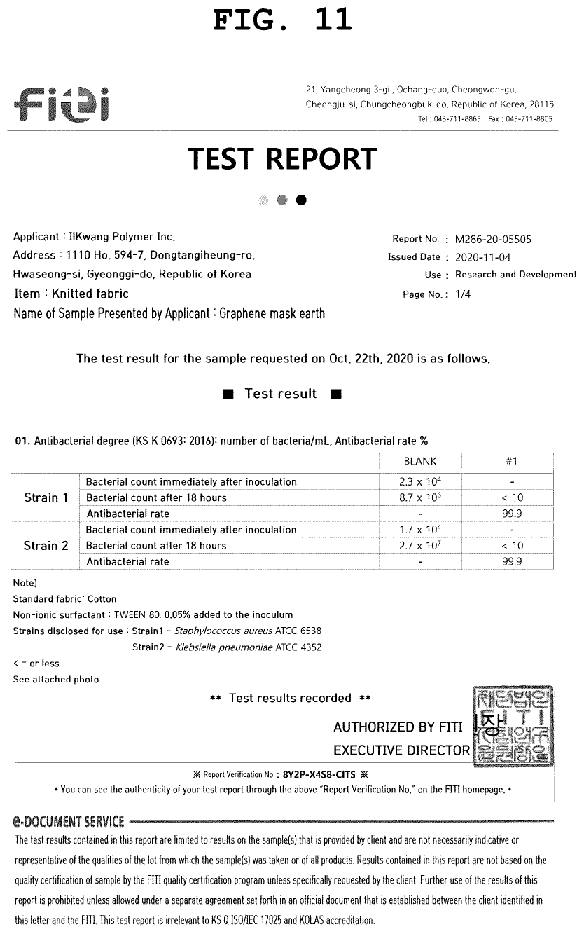

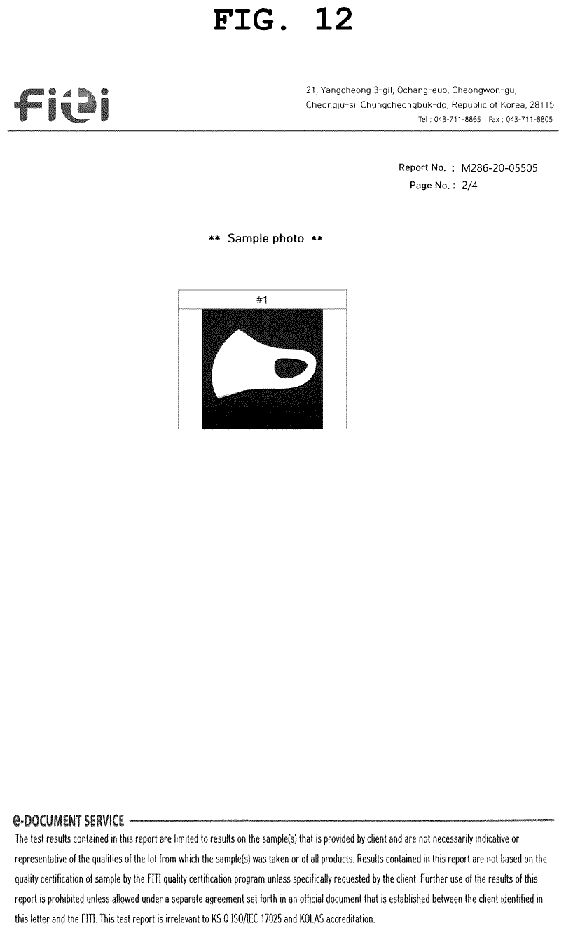

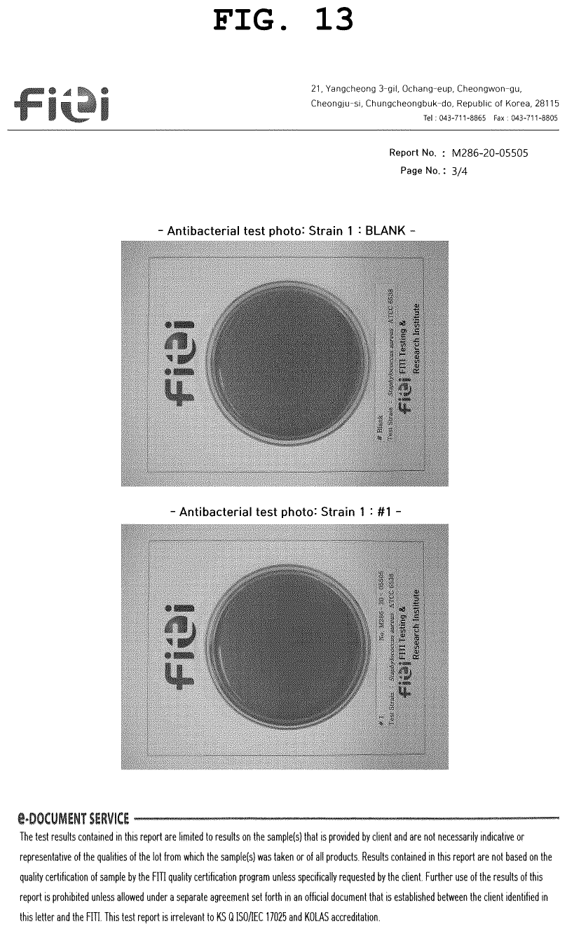

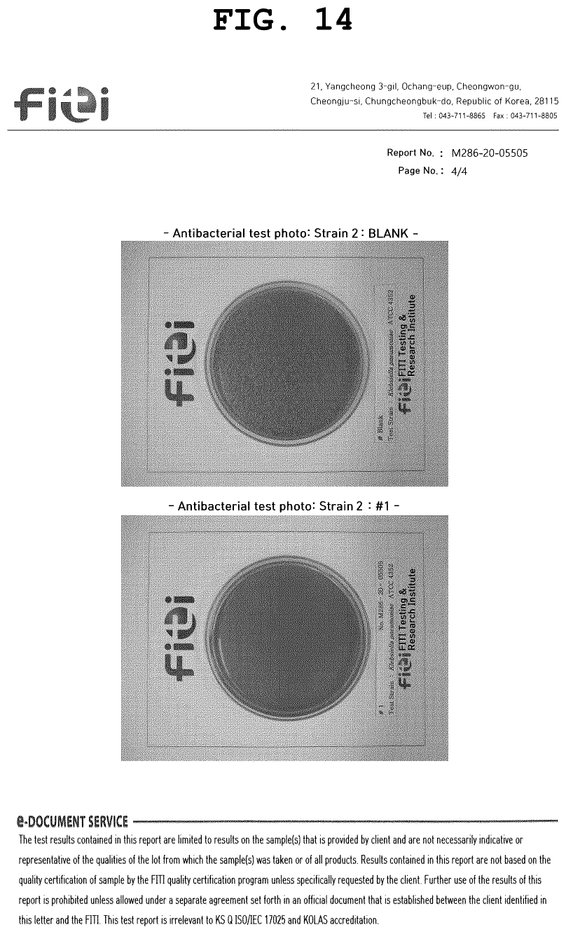

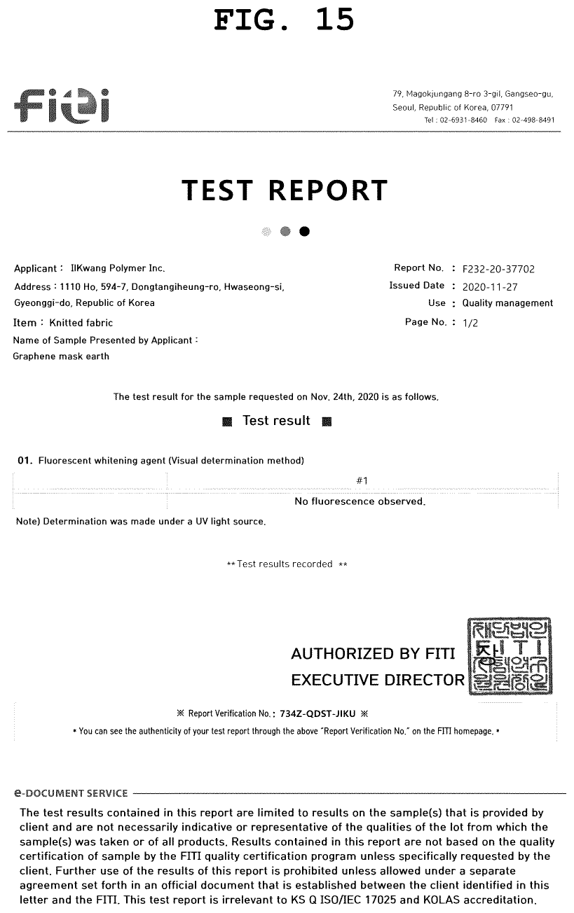

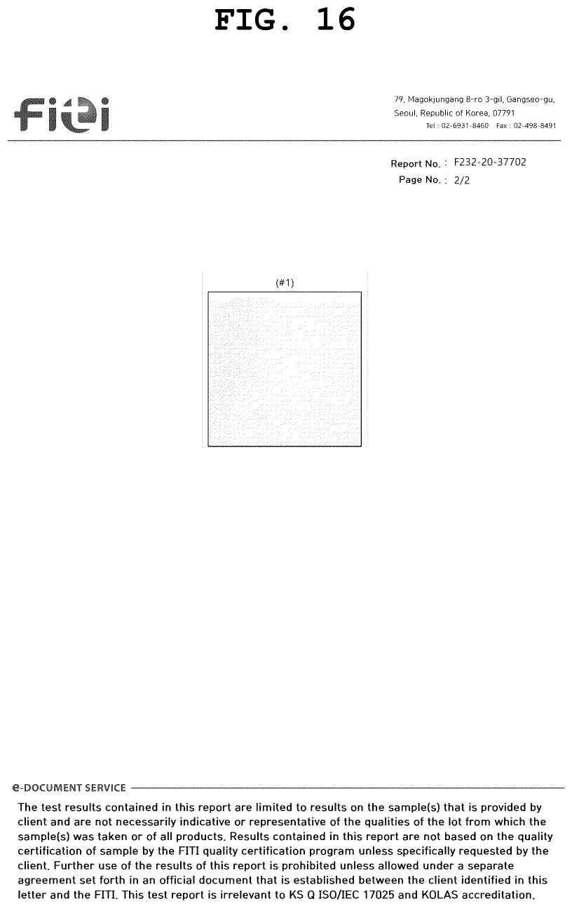

In addition, test results for the anti-fungal properties of the integrated mask with polyester produced through Example 6 are shown in FIGS. 8 to 10 below, test results for antibacterial properties are shown in FIGS. 11 to 14 below, and the presence or absence of fluorescent substances was tested and shown in FIGS. 15 and 16 below by requesting the FITI Testing Research Institute to conduct the consignment tests.

As shown in FIGS. 8 to 16 below, it may be seen that the integrated mask produced through Example 6 of the present disclosure has excellent anti-fungal and antibacterial properties and does not contain the fluorescent substances.

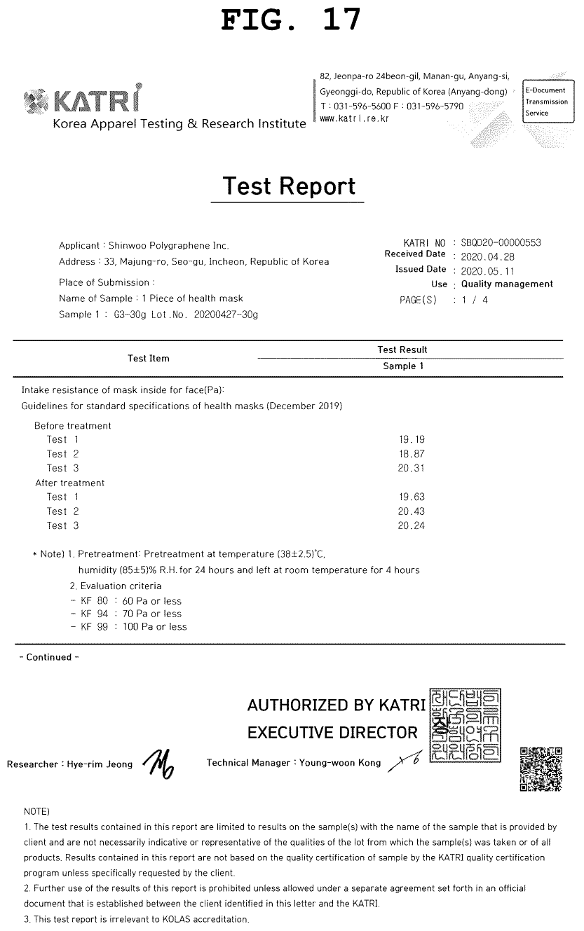

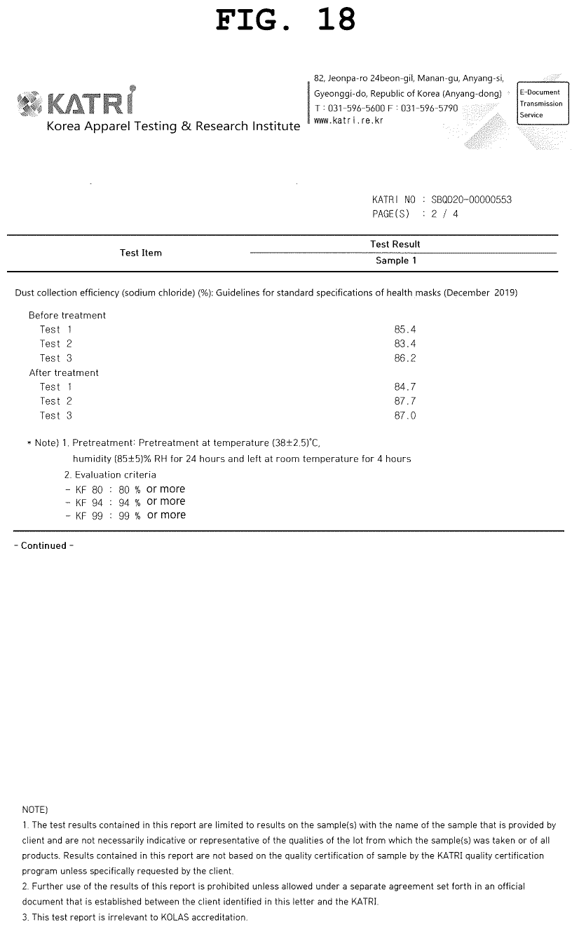

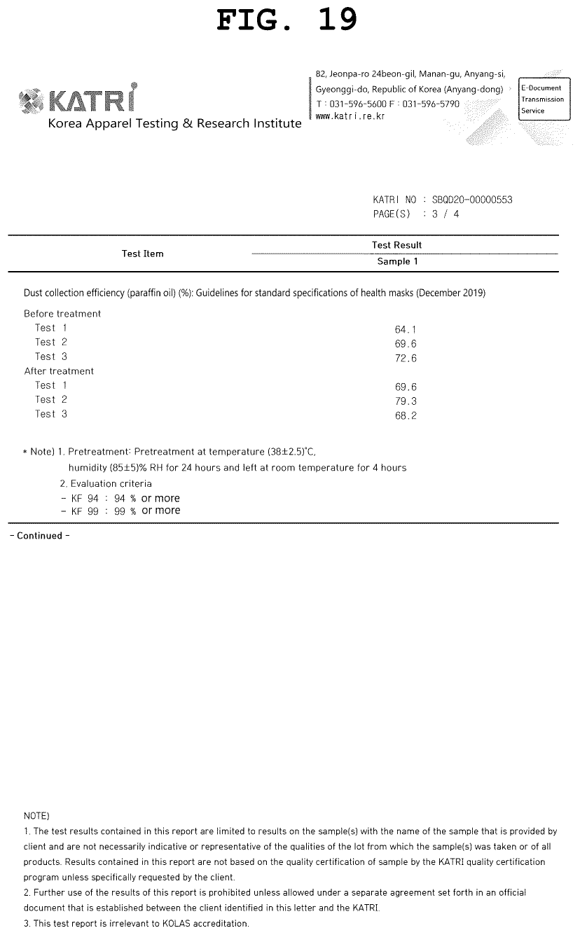

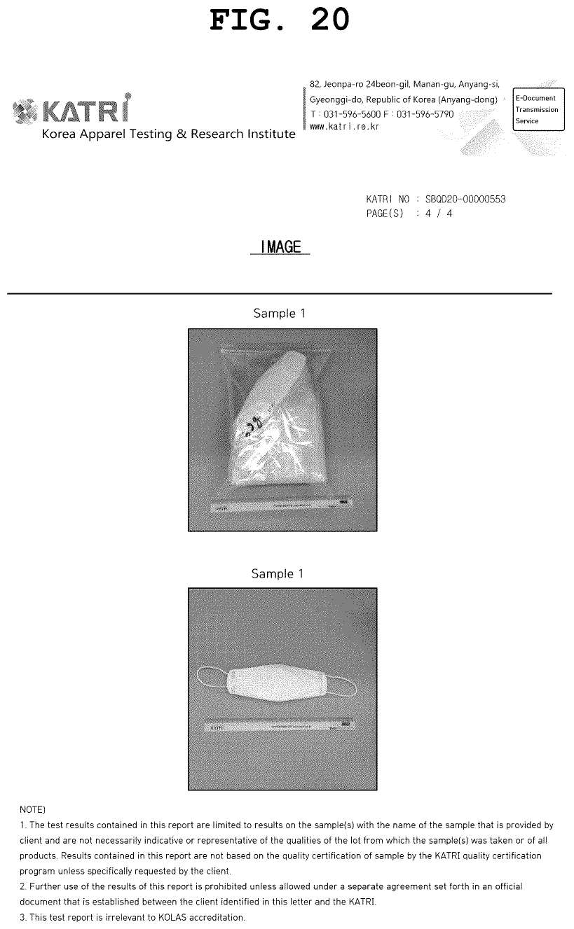

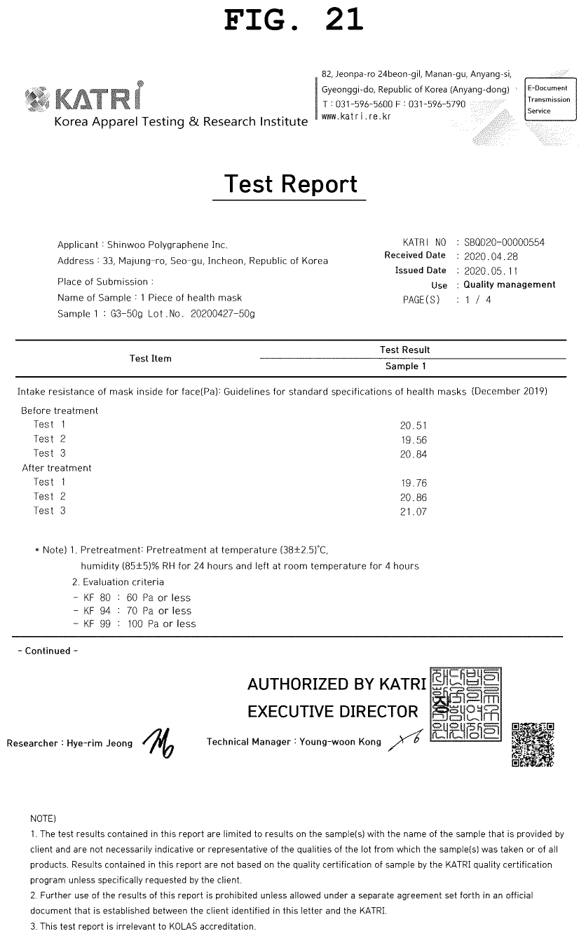

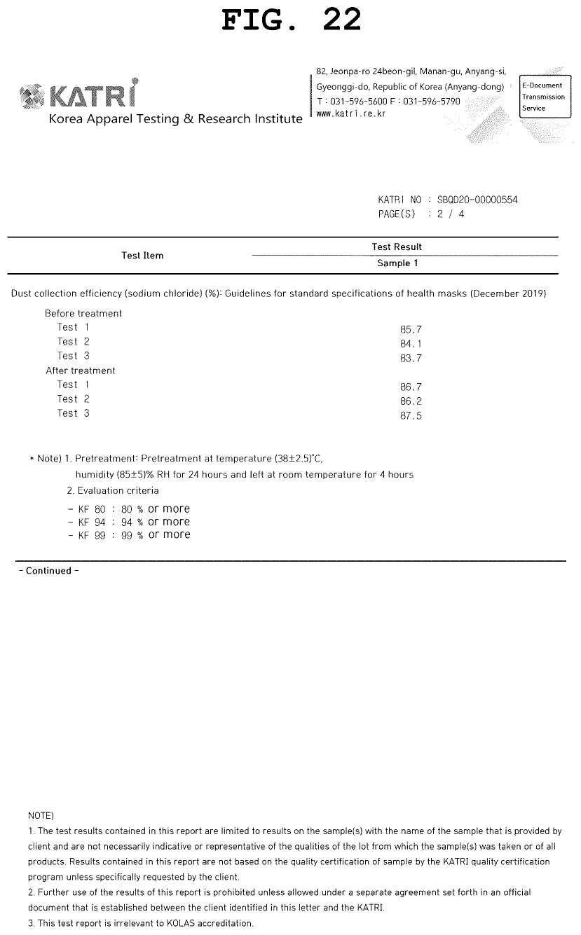

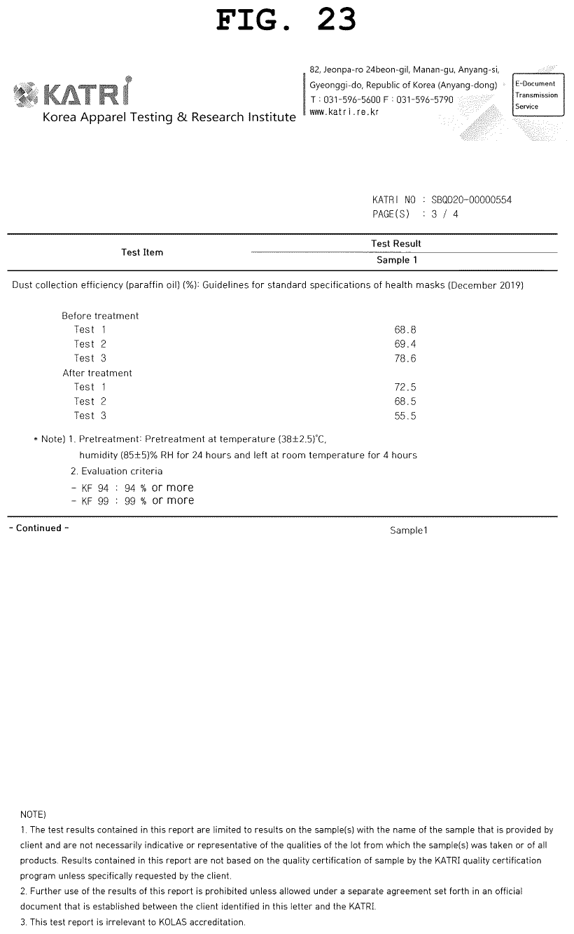

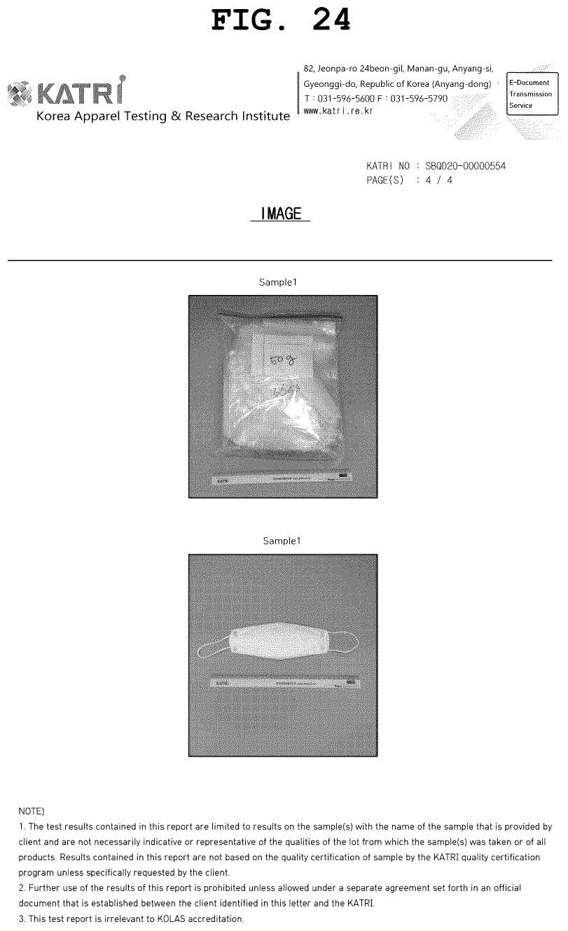

In addition, test results of the polyester mask for health produced in Example 7 for the intake resistance of the inner layer of the mask closest to the face and dust collection efficiency of the mask are shown in FIGS. 17 to 24 below by requesting the Korea Apparel Testing & Research Institute to conduct the consignment tests.

As shown in FIGS. 17 to 24 below, it may be seen that the polyester mask for health produced through Example 7 of the present disclosure exhibits excellent intake resistance of the inner layer of the mask closest to the face and dust collection efficiency.

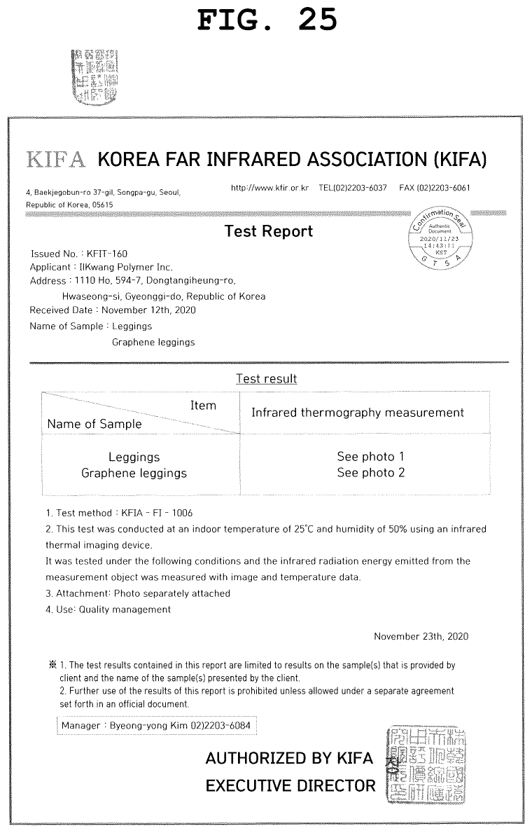

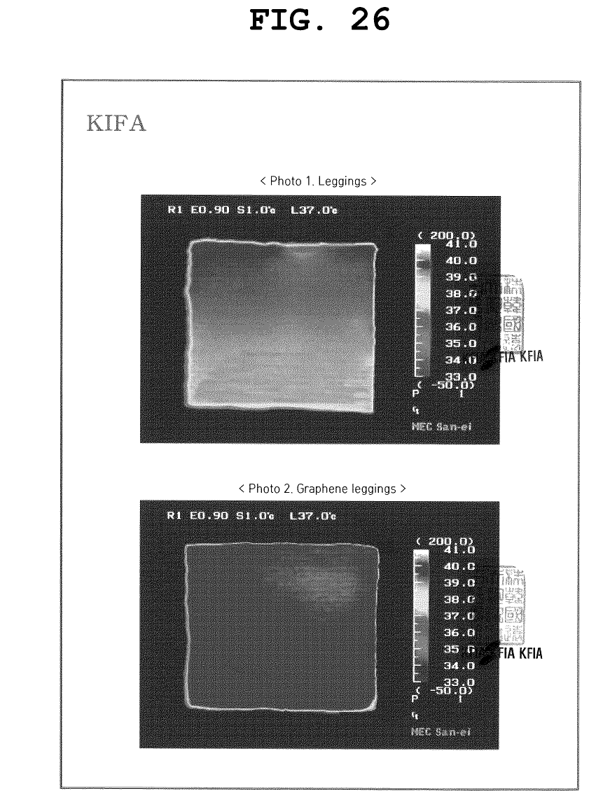

In addition, test results for the far-infrared ray radiation performance of the polyester leggings produced in Example 8 are shown in FIGS. 25 and 26 below by requesting the Korea Far-Infrared Association to conduct the consignment tests.

As shown in FIGS. 25 and 26 below, it may be seen that the polyester leggings produced through Example 8 of the present disclosure have an excellent far-infrared ray radiation effect.

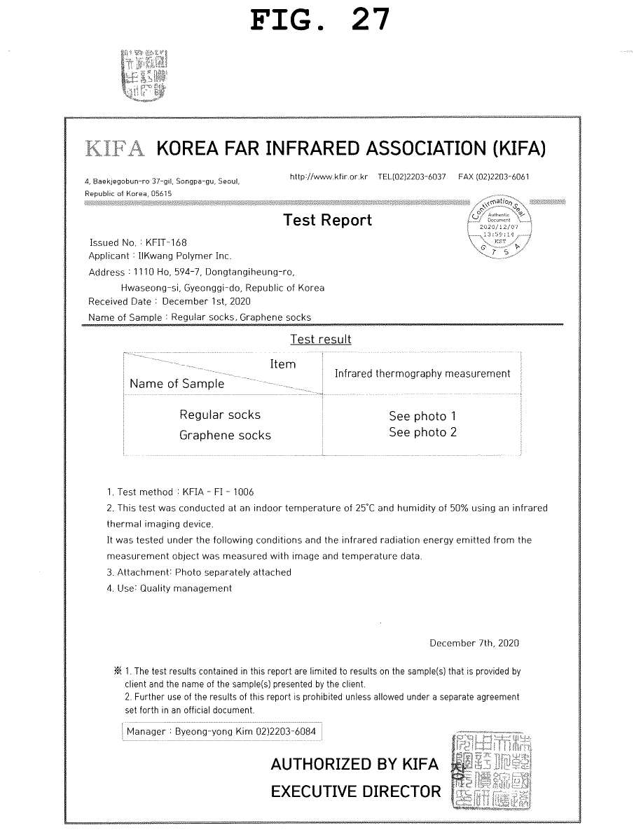

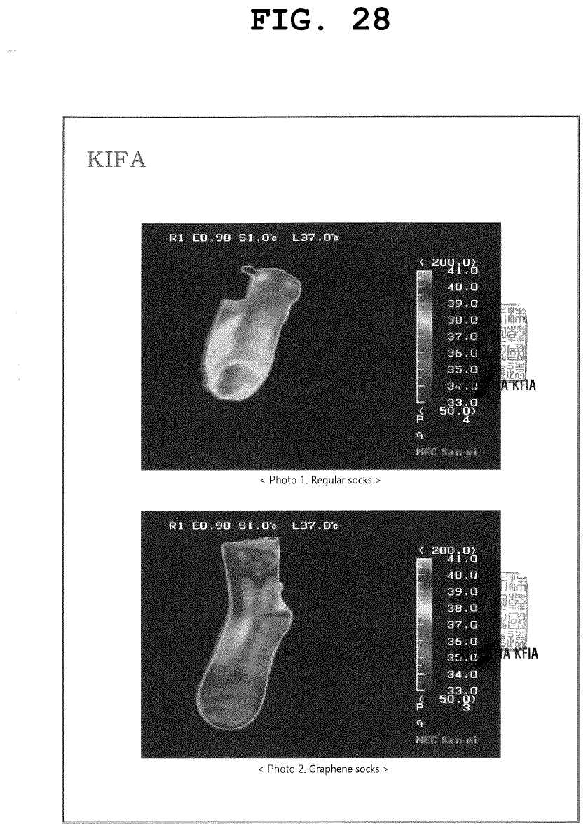

In addition, test results for the far-infrared ray radiation performance of the polyester socks produced in Example 9 are shown in FIGS. 27 and 28 below by requesting the Korea Far-Infrared Association to conduct the consignment tests.

As shown in FIGS. 27 and 28 below, it may be seen that the polyester socks produced through Example 9 of the present disclosure have an excellent far-infrared ray radiation effect.

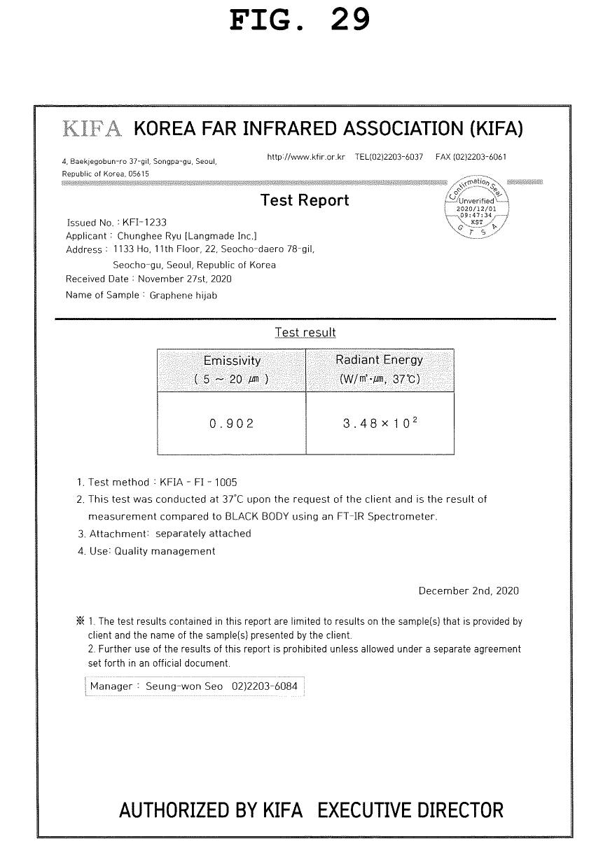

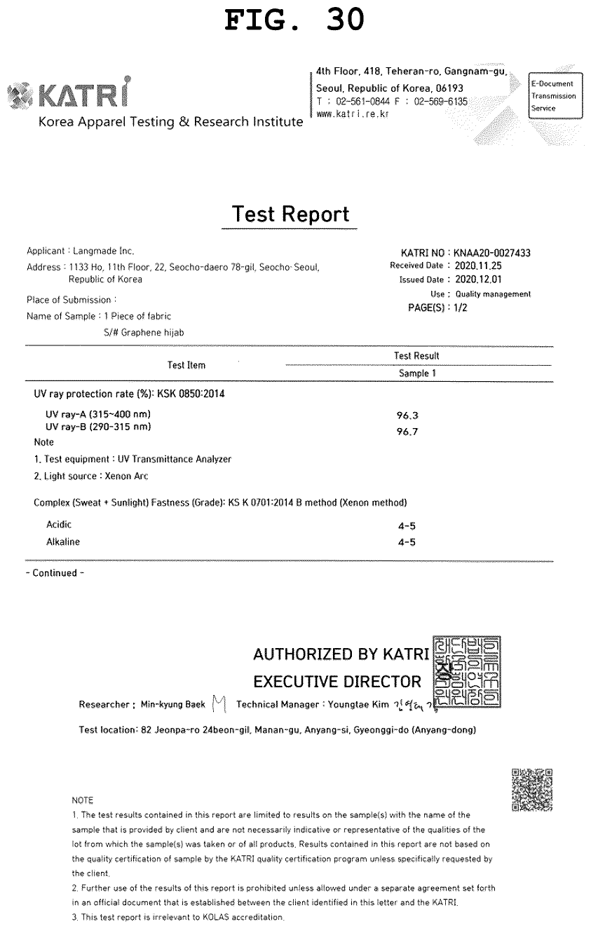

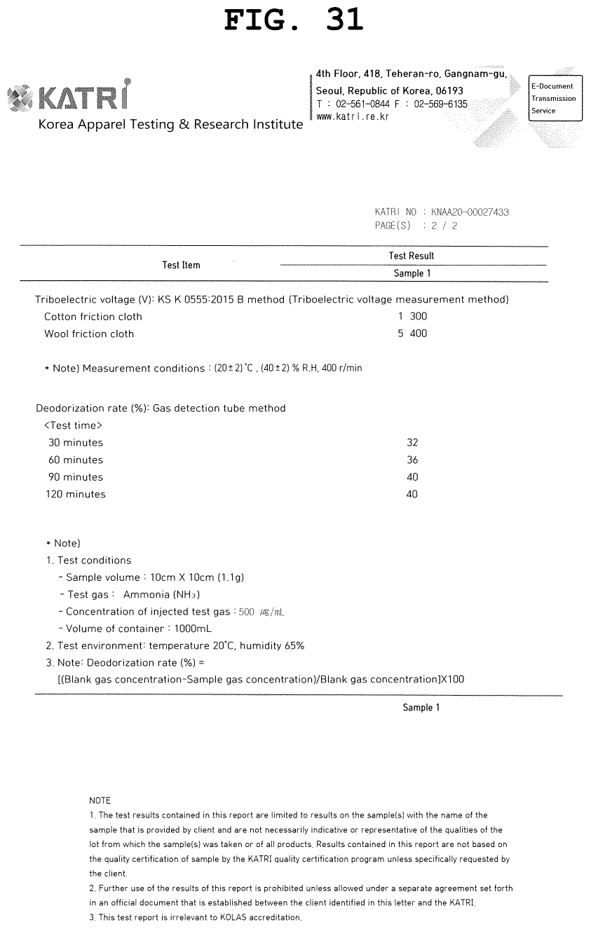

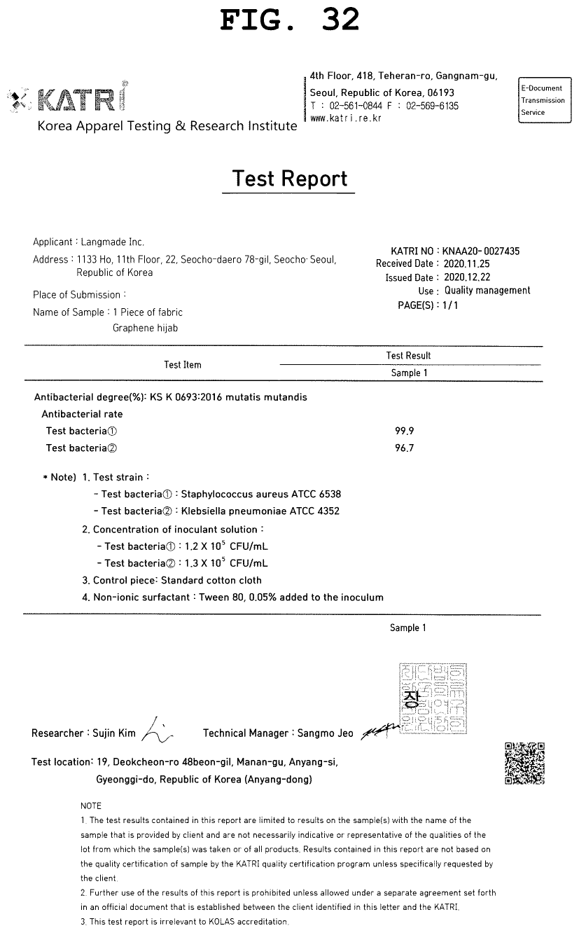

In addition, test results for the far-infrared ray radiation amount, ultraviolet ray (UV) blocking rate, composite fastness, triboelectric voltage, deodorization rate, and antibacterial property of the polyester hijab produced through Example 10 are shown in FIGS. 29 to 32 below.

As shown in FIGS. 29 to 32 below, it may be seen that the polyester hijab produced through Example 10 of the present disclosure has excellent far-infrared ray radiation amount, ultraviolet ray (UV) blocking rate, composite fastness, triboelectric voltage, deodorization rate, and antibacterial properties.

Therefore, the polyester master batch composition and the polyester yarn containing the composition according to the present disclosure may be understood to provide a polyester yarn imparted with far infrared ray radiation and antibacterial function, exhibiting lubricity, UV blocking properties, electrical conductivity, and heat dissipation properties, and having improved mechanical properties such as scratch resistance, abrasion resistance, tensile strength, flexural strength, and flexural modulus.

### INDUSTRIAL APPLICABILITY

The present disclosure relates to a polyester master batch composition and a polyester yarn containing the composition in which the polyester yarn is imparted with far-infrared ray radiation and antibacterial functions, exhibits lubricity, UV blocking properties, electrical conductivity, and has heat dissipation properties, and has improved mechanical properties such as scratch resistance, abrasion resistance, tensile strength, flexural strength, and flexural modulus.

1. A polyester master batch composition comprising a graphene oxide dispersion liquid.

2. The polyester master batch composition of claim 1, wherein the composition comprises 99% to 99.9% by weight of polyester and 0.1% to 1% by weight of the graphene oxide dispersion liquid.

3. The polyester master batch composition of claim 1, wherein the graphene oxide dispersion liquid comprises 100 parts by weight of ionized water, 0.1 to 1 part by weight of graphene, and 0.01 to 0.1 part by weight of a dispersant.

4. The polyester master batch composition of claim 3, wherein the dispersant comprises one or more selected from the group consisting of amine- and stearic acid-based materials.

5. A polyester yarn comprising the polyester master batch composition of claim 1.

6. The polyester yarn of claim 5, wherein the polyester yarn contains the polyester master batch composition in an amount of 50 to 2000 ppm.
